(19) United States
(12) Patent Application Publication
(10) Pub. No.: US 2024/0098828 A1
(43) Pub. Date: Mar. 21, 2024

(54) Low Power Data Buffering for Maintaining a Bluetooth Connection

(71) Applicant: Apple Inc., Cupertino, CA (US)

(72) Inventors: Yann LY-GAGNON, San Francisco, CA (US); Chen GANIR, San Jose, CA (US); Shlomo BEN-SHOSHAN, Kadima-Tzoran (IL); Yair SHAPIRA, Sdei Hemed (IL)

(21) Appl. No.: 18/470,031

(22) Filed: Sep. 19, 2023

Related U.S. Application Data
(60) Provisional application No. 63/376,134, filed on Sep. 19, 2022.

(51) Int. Cl. H04W 76/19; H04W 52/02

(52) U.S. Cl. CPC H04W 76/19; H04W 52/0248

(57) ABSTRACT

A first user equipment (UE) configured to receive data from a second UE over a short-range connection, wherein the data is received when an application processor of the first UE is in a lower power state, buffer the data in a buffer while the application processor of the first UE is in the lower power state and transfer buffered data from the buffer to the application processor after the application processor exits the lower power state and enters an active state.

### PRIORITY/INCORPORATION BY REFERENCE

This application claims priority to U.S. Provisional Application Ser. No. 63/376,134 filed on Sep. 19, 2022 and entitled “Low Power Data Buffering for Maintaining a Bluetooth Connection,” the entirety of which is incorporated herein by reference.

### BACKGROUND

A user equipment (UE) may establish a short-range connection (e.g., Bluetooth, Bluetooth Low Energy (BLE), etc.) to another device. In accordance with a variety of different power saving mechanisms, the UE may not maintain the short-range connection to the other device when the application processor of the UE is asleep, e.g., to avoid the power consumption associated with waking up the application processor. However, this may prevent the other device from performing certain types of tasks for the UE. Accordingly, there is a need for mechanisms configured to maintain a short-range connection between the UE and another device in a power efficient manner.

### SUMMARY

Some example embodiments are related to first user equipment (UE) comprising circuitry configured to perform operations. The operations include receiving data from a second UE over a short-range connection, wherein the data is received when an application processor of the first UE is in a lower power state, buffering the data in a buffer while the application processor of the first UE is in the lower power state and transferring buffered data from the buffer to the application processor after the application processor exits the lower power state and enters an active state.

Other example embodiments are related to a method performed by a first user equipment (UE). The method includes receiving data from a second UE over a short-range connection, wherein the data is received when an application processor of the first UE is in a lower power state, buffering the data in a buffer while the application processor of the first UE is in the lower power state and transferring buffered data from the buffer to the application processor after the application processor exits the lower power state and enters an active state.

Still further example embodiments are related to a processor of first user equipment (UE) configured to receive data from a second UE over a short-range connection, wherein the data is received when an application processor of the first UE is in a lower power state, buffer the data in a buffer while the application processor of the first UE is in the lower power state and transfer buffered data from the buffer to the application processor after the application processor exits the lower power state and enters an active state.

### BRIEF DESCRIPTION OF THE DRAWINGS

FIG. 1 shows an example arrangement according to various example embodiments.

FIG. 2 shows an example user equipment (UE) according to various example embodiments.

FIG. 3 shows a method for low power data buffering according to various example embodiments.

FIG. 4 shows a signaling diagram for low power data buffering according to various example embodiments.

FIG. 5 shows an example of a flow of data at the firmware layer according to various example embodiments.

### DETAILED DESCRIPTION

The example embodiments may be further understood with reference to the following description and the related appended drawings, wherein like elements are provided with the same reference numerals. The example embodiments relate to maintaining a short-range connection between two devices in a power efficient manner.

The example embodiments are described with regard to a user equipment (UE). However, reference to a UE is merely provided for illustrative purposes. The example embodiments may be utilized with any electronic component that is equipped with the hardware, software, and/or firmware to wirelessly exchange signals with a network and/or another separate device. Therefore, the UE as described herein is used to represent any electronic component.

The example embodiments are also described with regard to maintaining a Bluetooth connection between two UEs. Those skilled in the art will understand that Bluetooth (e.g., Bluetooth, Bluetooth Low-Energy (BLE), etc.) is a specific type of communication protocol that enables short-range communication between two or more devices. While the example embodiments provide benefits to Bluetooth, the example embodiments are not limited to Bluetooth and may be implemented using any appropriate type of wireless communication protocol. Therefore, any reference to terms such as, “Bluetooth,” “BLE,” “short-range communication protocol,” “short-range connection,” or “short-range communication link” are provided for illustrative purposes and not intended to limit the example embodiments to any particular type of wireless communication protocol.

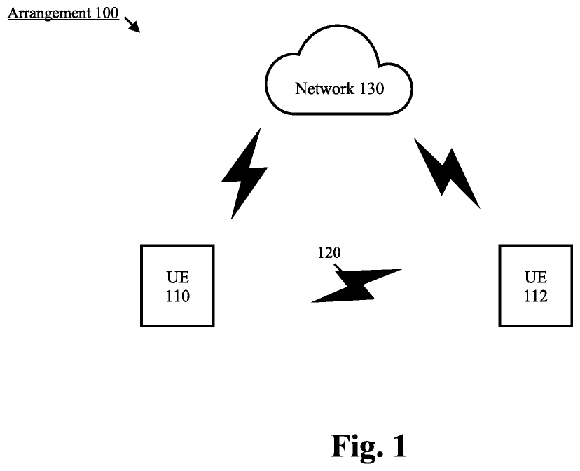

A UE may experience a power drain when it wakes up its application processor from a sleep mode or other lower-power state. When a first UE is connected to second UE via Bluetooth, the second UE may send messages to the first UE that trigger the first UE to wake up its application processor. Thus, in accordance with various power saving mechanisms, a UE may not allow another device to remain connected via Bluetooth when the UE's application processor is asleep (e.g., in a lower-power state than an operating state). As will be described in more detail below with regard to the arrangement 100 of FIG. 1, it has been identified that these types of power saving mechanisms may prevent the implementation of certain types of functionalities. The example embodiments introduce an alternative mechanism that enables the UE to maintain a short-range connection to another device in a power efficient manner.

FIG. 1 shows an example arrangement 100 according to various example embodiments. The arrangement 100 includes a UE 110, a UE 112 and a network 130. The network 130 may be a fifth generation (5G) new radio (NR) network, a long term evolution (LTE) network, a legacy cellular network, a wireless local area network (WLAN), a mesh network, or any other appropriate type of network.

The UEs 110, 112 and the remote device 114 may access the network 130 via an access node. Those skilled in the art will understand that any appropriate type of association procedure may be performed for the UEs 110, 112 to connect to the network 130 via the access node. However, the manner in which the UEs 110, 112 may connect to the network 130 is beyond the scope of the example embodiments nor do the example embodiments require either the UE 110 or the UE 112 to be connected to the network 130.

To provide a non-limiting example within the context of the example arrangement 100, the UE 110 may be a smart watch and the UE 112 may represent a wearable sensor (e.g., a glucose monitor, an electrocardiogram (EKG) sensor, a biosensor, etc.). However, as indicated above, the example embodiments are not limited to these types of devices and the UEs 110, 112 each may represent any type of electronic component that is configured for wireless communication (e.g., mobile phones, tablet computers, desktop computers, smartphones, phablets, embedded devices, wearables, Internet of Things (IoT) devices, sensors, etc.).

The UEs 110, 112 may communicate with one another using a short-range communication protocol (e.g., Bluetooth, BLE, etc.). Accordingly, when the UE 110 and the UE 112 are within proximity of one another (e.g., within a distance in which BLE communications may be performed), the UE 110 and the UE 112 may exchange data over the communication link 120. In some implementations, the UE 110 and the UE 112 may have a companion relationship where the UE 110 is a source device, and the UE 112 is an accessory device. Thus, in some examples, the UE 110 may connect to a network 130 and relay data exchanged with the network 130 to the UE 112 over the short-range communication link 120.

In accordance with various power saving mechanisms, the UE 110 may not maintain the Bluetooth connection to the UE 112 when the application processor of the UE 110 is asleep (or operating in a lower-power or reduced-power state). This type of power saving mechanism is intended to prevent another device from being able to wake up the application processor of the UE 110, thereby triggering the corresponding power drain. However, it has been identified that this type of behavior may prevent certain types of functionalities.

Returning to the example introduced above, assume that the UE 110 is a smart watch, and the UE 112 is a wearable sensor (e.g., glucose monitor, EKG, biosensor, etc.). The UE 112 may be a third party device that is configured to collect data from a user and provide the data to the UE 110 via the short-range communication link 120. However, the UE 110 may be configured to not maintain a connection to third party devices when the application processor of the UE 110 is asleep. While this mechanism may provide power saving benefits to the UE 110, it has been identified that this mechanism may prevent the UE 112 from being able to reliably trigger alarms by sending a signal to the UE 110. For example, a glucose monitor may be unable to notify the UE 110 about a low sugar detection event when the application processor of the UE 110 is asleep. The example mechanisms introduced herein utilize a different approach to UE power saving which allows the UE 110 to remain connected to other devices in a power efficient manner.

As mentioned above, the example embodiments may support the implementation of certain types of functionality between devices, such as a smart watch and a wearable sensor. However, the example embodiments introduced herein are not limited to maintaining a connection between these two types of devices. The example embodiments introduced herein may be used by any appropriate type of device configured to establish a short-range connection to one or more other devices.

According to some aspects, the example embodiments introduce a low power buffer that may be used by the UE 110 to maintain the short-range connection in a power efficient manner. The example low power buffer may be utilized to selectively wake up the application processor. Thus, instead of waking up the application processor every time a signal is received or preventing a connection from being maintained while the application processor is asleep, the example buffer may be utilized to maintain the short-range connection in a power efficient manner. To provide one general example, the UE 110 may be configured to buffer one or more types of signal (e.g., a generic attribute profile (GATT) indication, etc.) received from the UE 112 over the short-range communication link 120 while the application processor of the UE 110 is asleep. However, the UE 110 may be configured to wake up its application processor in response to receiving one or more other types of signal over the short-range communication link 120. For example, the application processor may be awakened when an indication of a low blood sugar event detection is received from the UE 112. The above example is merely provided for illustrative purposes and is not intended to limit the example embodiments in any way.

As indicated above, in some embodiments, the buffer may be utilized to buffer certain messages/signals, e.g., generic attribute profile (GATT) indications, received from the remote device while the application processor of the UE is asleep. In other embodiments, the buffer may be utilized to buffer one or more other types of information, such as, but not limited to, an indication that the short-range connection has been disconnected. Specific examples of how this example buffer may be utilized are provided in detail below. The example buffer and the other example mechanisms introduced herein may be used independently from one another, in conjunction with other currently implemented mechanisms related to maintaining short-range connection, with future implementations of mechanisms related to maintaining short-range connection or independently from other mechanisms related to maintaining short-range connection.

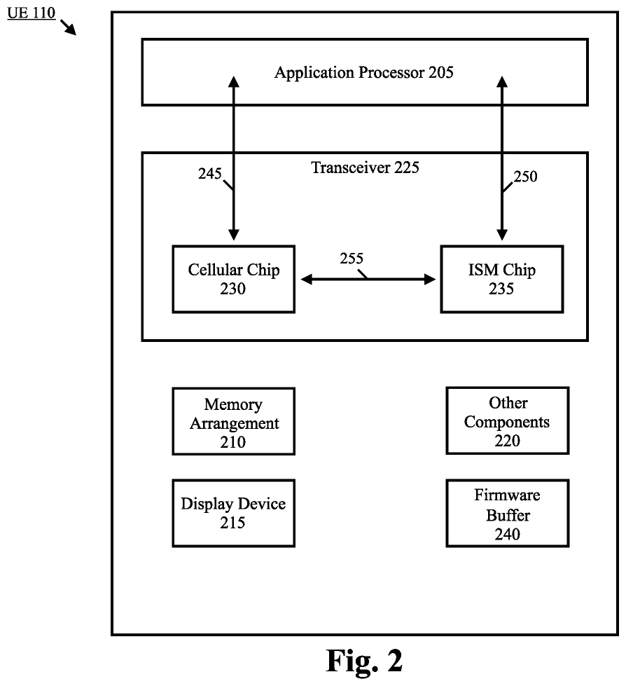

FIG. 2 shows an example UE 110 according to various example embodiments. The UE 110 may represent the UEs 110, 112 from the arrangement 100 of FIG. 1 or any other type of device configured to communicate directly with another device using a short-range communication protocol. The UE 110 may include an application processor 205, a transceiver 225, a cellular chip 230, an industrial scientific and medical (ISM) chip 235, a memory arrangement 210, a display device 215, a firmware buffer 240 and other components 220. The other components 220 may include, for example, an input/output (I/O) device, an audio input device, an audio output device, a power supply, a data acquisition device, ports to electrically connect the UE 110 to other electronic devices, sensors to collect data from a user, etc.

The application processor 205 may be configured to execute a plurality of applications for the UE 112. For example, the applications may include, but are not limited to, a web browser, a health monitoring application, and a voice call application. The example embodiments are described with regard to the application processor 205 utilizing a sleep mode to conserve power. Throughout this description, any reference to a power saving mode, a sleep mode, or other such period of inactivity being used by the application processor 205 does not necessarily mean putting all of the components of the UE 110 to sleep, in hibernation, or in a deactivated state. For example, the UE 110 may still exchange signals with another device (e.g., UE 112) over a short-range communication link and/or a network. Instead, the power saving mode described herein relates to conserving power by discontinuing at least a subset of processing functionality associated with the application processor.

The memory arrangement 210 may be a hardware component configured to store data related to operations performed by the UE 110. The display device 215 may be a hardware component configured to show data to a user. The display device 215 and an I/O device may be separate components or integrated together such as a touchscreen.

The transceiver 225 may be a hardware component configured to wirelessly transmit and/or receive data. Thus, the transceiver 225 may enable communication with other electronic devices directly or indirectly through a network. The transceiver 225 may operate on a variety of different frequencies or channels (e.g., set of consecutive frequencies) that are related to a cellular network and/or a WLAN network. The transceiver 225 may also perform wireless functionalities for short range communications such as Bluetooth, BLE, etc. Accordingly, the transceiver 225 may work in conjunction with a cellular chip 230 for the wireless functionalities related to cellular networks and an ISM chip 235 for the wireless functionalities for short-range communications such as Bluetooth, BLE, etc.

The components of the UE 112 may be disposed at least partially on an integrated circuit board (ICB). Accordingly, the cellular chip 230, the ISM chip 235, and the application processor 205 may be disposed on the ICB in which pathways may also exist between these components. For example, an interface 245 may be disposed to connect the cellular chip 230 to the applications processor 205 while interface 250 may be disposed to connect the ISM chip 235 to the applications processor 205. In addition, a coexistence interface 255 may be disposed to connect the cellular chip 230 to the ISM chip 235. Those skilled in the art will understand the manner in which the cellular chip 230, the ISM chip 235, and the application processor 205 may be disposed on the ICB as well as the manner in which the interfaces or pathways 145, 150, 155 may be provided for the interconnections. The example embodiments may be implemented in any of these or other configurations of a UE.

In addition, the UE 110 may include the firmware buffer 240. The firmware buffer 240 may perform various operations related to buffering certain types of signals that may be exchanged over a short-range communication link. The firmware buffer 240 may enable the UE 110 to maintain a short-range connection in a power-efficient manner. The firmware buffer 240 may be implemented as a separate incorporated component of the UE 110, may be a modular component coupled to the UE 110, e.g., an integrated circuit. For example, the integrated circuit may include input circuitry to receive signals and processing circuitry to process the signals and other information. However, in some embodiments, the operations performed by the firmware buffer 240 may instead be performed by an integrated circuit without firmware, a baseband processor, the application processor 205, any combination thereof or any other appropriate component. Thus, the example embodiments are not required to utilize a buffer implemented in firmware and may utilize a buffer implemented in any appropriate manner. In addition, reference to a single firmware buffer 240 is provided for illustrative purposes, the UE 110 may be equipped with any appropriate number of firmware buffers.

As indicated above, the example embodiments introduce a low power buffering mechanism associated with short-range communication. According to some aspects, the low power buffering mechanism is described with regard to the UE 110 buffering GATT indications. Generally, GATT defines the way in which two or more devices exchange data over a short-range communication link (e.g., Bluetooth, BLE, etc.). With regard to the arrangement 100 of FIG. 1, the UE 112 may be triggered to send a GATT indication or GATT notification comprising data to the UE 110. Those skilled in the art will understand that GATT, indication and notification are defined in various Bluetooth/BLE specifications. In this description, these terms may be used in the manner in which they are defined in Bluetooth/BLE specifications, or in a manner consistent with such definitions, and may be modified in accordance with the example embodiments described herein.

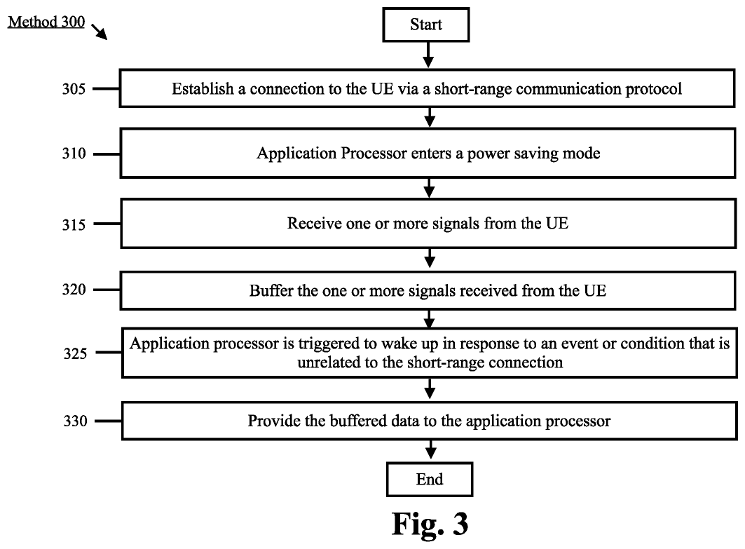

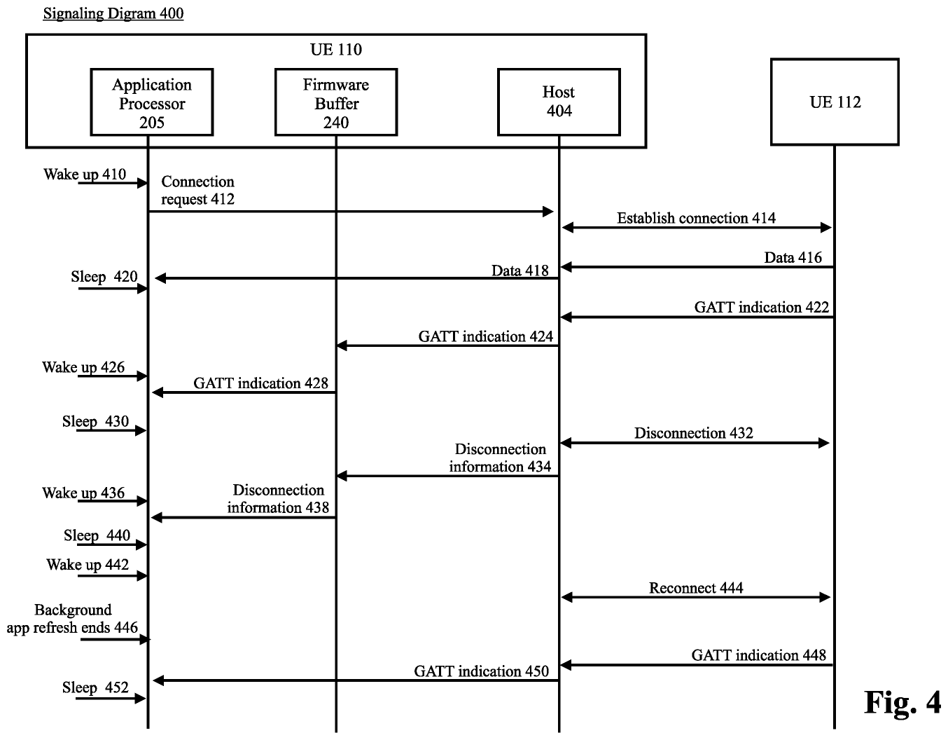

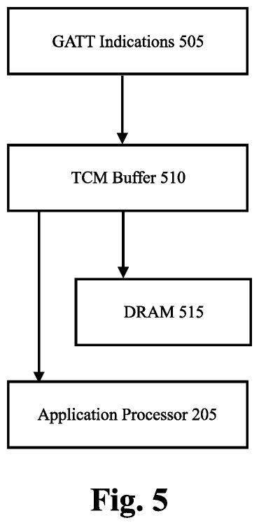

FIG. 3 shows a method 300 for low power data buffering according to various example embodiments. The method 300 is described from the perspective of the UE 110 of the arrangement 100 of FIG. 1 and provides a general example of how the example low power data buffering may be utilized by the UE 110. Additional details regarding low power data buffering are provided below in FIGS. 4-5.

In 305, the UE 110 establishes a connection to the UE 112 via a short-range communication protocol. For example, the UE 110 may establish a Bluetooth connection, a BLE connection or any other appropriate type of wireless connection to the UE 112.

In 310, the application processor 205 of the UE 112 enters a power saving mode. For example, the display device 215 of the UE 110 may be switched off and/or background processes for applications installed on the UE 110 may not be scheduled to execute until a subsequent time window. Thus, the application processor 205 has an opportunity to conserve power and enter a sleep mode (e.g., a period of inactivity). As indicated above, while the application processor 205 of the UE 110 is asleep, other components of the UE 110 (e.g., the transceiver 225, cellular chip 230, ISM chip 235, baseband processor, etc.) may continue to perform various different operations.

In 315, the UE 110 receives one or more signals from the UE 112. For example, the UE 110 may receive one or more GATT indications from the UE 112.

In 320, the UE 110 makes a determination to buffer the one or more signals received from the UE 112. For example, the firmware buffer 240 may be configured to buffer GATT indications while the application processor of the UE 110 is asleep. However, the example embodiments are not limited to GATT indications. Other signals such as, but not limited to, GATT notifications, disconnection information, and/or other message types may also be buffered.

In 325, the application processor 205 is triggered to wake up in response to an event or condition that is unrelated to the short-range connection. For example, user input may activate the display device 215 or a background application refresh may occur.

In 330, the firmware buffer 240 may provide the buffered data to the application processor 205. Thus, instead of waking up the application processor 205 in response to receipt of the GATT indication, the GATT indication is buffered and processed by the application processor 205 after it wakes up, e.g., for a reason unrelated to maintaining the short-range connection with the UE 110. Accordingly, receipt of messages corresponding to one or more message types will not cause the application processor 205 to exit a lower power state, and the received messages will instead be buffered until the application processor 205 exists the lower power state for a different reason.

FIG. 4 shows a signaling diagram 400 for low power data buffering according to various example embodiments. The signaling diagram 400 includes the UE 110 and the UE 112 of the arrangement 100 of FIG. 1.

The signaling diagram 400 shows UE 110 components including an application processor 205, the firmware buffer 240 and a host 402. The host 402 (e.g., Bluetooth (BT) host, BLE host, etc.), represents an entity (e.g., a driver, one or more layers of a protocol stack, etc.) configured to manage the short-range connection between the UE 110 and the UE 112.

In 410, the application processor 205 is awake (e.g., in an operating state). For example, an application may be running on the application processor 205 in the foreground, the display device 215 may be powered on, a background application refresh may be executing, and/or any other appropriate type of operation may be performed by the application processor 205.

In 412, the application processor 205 sends a signal to the host 402 requesting that the host connect the UE 110 to another device using a short-range communication protocol (e.g., Bluetooth, BLE, etc.). In 414, the host 402 establishes a connection to UE 112. The manner in which the short-range connection is established is beyond the scope of the example embodiments. Those skilled in the art will understand that any appropriate type of connection procedure may be performed to establish the short-range communication link between the UE 110 and the UE 112.

In 416, the host 404 receives data from the UE 112. For example, the UE 112 may transmit one or more GATT indications and/or GATT notifications to the UE 110. In 418, the host 404 forwards the data to the application processor 205 for further processing. In 420, the application processor enters a sleep mode (or other such lower power state). However, the BT host 404 and the UE 112 remain connected via the short-range communication link. Thus, in this example, between 410 and 420, the application processor 205 is awake in an active mode of processing.

In 422, the host 404 receives a message, e.g., a GATT indication, from the UE 112. In 424, the message, e.g., the GATT indication, is forwarded to the firmware buffer 240. At this time, the application processor 205 is in a sleep mode. Thus, instead of waking up the application processor 205 in response to the received message, the data is buffered to allow the application processor 205 to remain in the lower power state and thereby save power.

In 426, the application processor 205 is triggered to wake up for a reason that is unrelated to the short-range connection to the UE 112. For example, the display device 215 may be powered on or a background application refresh may be scheduled to occur. In 428, the data is transferred from the firmware buffer 240 to the application processor 205, e.g., for processing. Thus, in this example, the data received over the short-range connection is not provided to the application processor 205 until the application processor 205 wakes up for a different reason. Receipt of one or more message types will not trigger the application processor 205 to exit the lower power state.

In other examples, the UE 110 may decide to wake up the application processor 205 instead of buffering the data at the firmware buffer 240, based on the type of signal or message received, and/or the contents of the data payload. For instance, in a scenario where the UE 110 is a smart watch and the UE 112 is a wearable sensor, the UE 110 may decide to wake up the application processor in response to a received signal or message, e.g., to allow an alarm to be triggered at the UE 110 to alert the user to an event or condition. In further examples, a condition at the firmware buffer 240 may trigger the firmware buffer to cause the application processor 205 to wake up and receive buffered data. For instance, when the firmware buffer 240, or a ring of the buffer, is full, the UE 110 may wake up the application processor 205 to process the buffered data.

FIG. 5 shows an example of a flow of data at the firmware layer according to various example embodiments. This example is described from the perspective of the UE 110 utilizing a firmware buffer configured to handle GATT indications. Those skilled in the art how the example concepts described with regard to FIG. 5 may be applied to other types of signals and/or data.

FIG. 5 shows GATT indications 505, a tightly couple memory (TCM) buffer 510 of the firmware buffer 240, a dynamic random access memory (DRAM) 515 and the application processor 205.

Those skilled in the art will understand that a GATT indication may comprise ATT handle value indications. The GATT indications 505 are provided to the TCM buffer 510. The TCM buffer may be of a size (M) and may comprise a header (hdr) and multiple attributes (attr). Each attr may comprise an ATT Asynchronous Connectionless (ACL) packet, a timestamp and/or any other appropriate type of information.

When the TCM buffer 510 is full, the TCM buffer 510 may wake up the DRAM 515 to copy the buffered data. In some embodiments, the DRAM 515 may only need to be awake to perform the copy operation. In addition, the TCM buffer 510 may copy the buffered data to the DRAM 515 when the application processor 205 is awake.

The TCM buffer 510 may also send a signal to the application processor 205. The signal may be sent when the application processor 205 wakes up, when the TCM buffer 510 is triggered to wake up the application processor (e.g., based on a type of signal and/or data, etc.), when the TCM buffer 510 is full, or for any other appropriate reason.

Returning to the signaling diagram 400 of FIG. 4, in 430, the application processor 205 enters a sleep mode. In 432, the short-range connection is disconnected. The manner in which the short-range connection is disconnected is beyond the scope of the example embodiments. Those skilled in the art will understand that any appropriate type of event may occur and/or procedure may be performed to disconnect the short-range communication link between the UE 110 and the UE 112.

In 434, information related to the disconnection event is buffered at the firmware buffer 240. In this example, a single buffer handles both GATT indications and disconnection information. However, the example embodiments are not limited to a single buffer and may utilize any appropriate number of buffers configured to handle any appropriate number of different types of signals or information.

At this time, the application processor 205 is asleep (e.g., in a lower power state). Thus, instead of waking up the application processor 205 in response to receiving the disconnection information, the firmware buffer 240 buffers the disconnection information to allow the application processor 205 to remain asleep and save power.

In 436, the application processor 205 is triggered to wake up for a reason that is unrelated to the short-range connection to the UE 112. For example, the display device 215 may be powered on or a background application refresh may be scheduled to occur. In 438, the firmware buffer 240 transfers the buffered data to the application processor 205, e.g., for processing. Thus, in this example, the disconnection information is not provided to the application processor 205 until the application processor 205 wakes up for a reason other than receipt of the disconnection information.

In 440, the application processor 205 enters a sleep mode. In 442, the application processor wakes up. For example, the display device 215 may be powered on or a background application refresh may be scheduled to occur.

In 444, the host 404 reconnects to the UE 112. According to some aspects, the UE 110 may wait until the application processor 205 wakes up for a reason unrelated to the UE 112 to reconnect the short-range connection (e.g., background application refresh, etc.). Once the connection is established, even if the background application refresh is completed, the application processor 205 may remain awake to receive data from the UE 112 (e.g., GATT indications, etc.). After the data is received and/or a condition occurs (e.g., timer expiry, a duration of time with no data reception, etc.), the UE 110 may allow the application processor 205 to go to sleep and return to utilizing the firmware buffer 240. Accordingly, the UE 110 may adapt its behavior with regard to the short-range connection with the UE 112 to the application processor 205 activity. An example of this is shown in the signaling diagram 400, where in 446 a background application refresh ends. In 448, the host 404 receives a GATT indication from the UE 112 after the background application refresh has ended. In 450, the host 404 forwards the data to the application processor 205. In 452, the application processor 205 enters a sleep mode. At this point, as demonstrated above in 422-428, the UE 110 may utilize the firmware buffer 240 to allow the application processor to remain in a lower power state and conserve power.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A first user equipment (UE) comprising circuitry configured to perform operations comprising:
receiving data from a second UE over a short-range connection, wherein the data is received when an application processor of the first UE is in a lower power state;
buffering the data in a buffer while the application processor of the first UE is in the lower power state; and
transferring buffered data from the buffer to the application processor after the application processor exits the lower power state and enters an active state.

2. The first UE of claim 1, wherein the application processor is triggered to exit the lower power state to perform a background application refresh.

3. The first UE of claim 2, wherein the data comprises a generic attribute profile (GATT) indication.

4. The first UE of claim 2, wherein the data comprises an indication that the short-range connection between the first UE and the second UE has been disconnected.

5. The first UE of claim 4, wherein the application processor returns to the lower power state after processing the data while in the active state and remains in the lower power state until a next background application refresh before reestablishing the short-range connection to the second UE.

6. The first UE of claim 5, the operations further comprising:
delaying, after reestablishing the short-range connection, transitioning the application processor to the lower power state until a GATT indication is received from the second UE over the short-range connection and processed by the application processor.

7. The first UE of claim 1, wherein the buffer is implemented in firmware.

8. The first UE of claim 1, wherein the application processor is triggered to exit the lower power state based on a trigger that is unrelated to the short-range connection.

9. The first UE of claim 1, wherein the application processor is triggered to exit the lower power state based on a type of data received from the second UE.

10. The first UE of claim 1, wherein the data comprises a notification corresponding to an event detected by the second UE.

11. A method performed by a first user equipment (UE) comprising:
receiving data from a second UE over a short-range connection, wherein the data is received when an application processor of the first UE is in a lower power state;
buffering the data in a buffer while the application processor of the first UE is in the lower power state; and
transferring buffered data from the buffer to the application processor after the application processor exits the lower power state and enters an active state.

12. The method UE of claim 11, wherein the application processor is triggered to exit the lower power state to perform a background application refresh.

13. The method UE of claim 12, wherein the data comprises a generic attribute profile (GATT) indication.

14. The method UE of claim 12, wherein the data comprises an indication that the short-range connection between the first UE and the second UE has been disconnected.

15. The method UE of claim 14, wherein the application processor returns to the lower power state after processing the data while in the active state and remains in the lower power state until a next background application refresh before reestablishing the short-range connection to the second UE.

16. The method UE of claim 15, further comprising:
delaying, after reestablishing the short-range connection, transitioning the application processor to the lower power state until a GATT indication is received from the second UE over the short-range connection and processed by the application processor.

17. The method UE of claim 11, wherein the buffer is implemented in firmware.

18. The method UE of claim 11, wherein the application processor is triggered to exit the lower power state based on a trigger that is unrelated to the short-range connection.

19. The method UE of claim 11, wherein the application processor is triggered to exit the lower power state based on a type of data received from the second UE.

20. A processor of first user equipment (UE) configured to:
receive data from a second UE over a short-range connection, wherein the data is received when an application processor of the first UE is in a lower power state;
buffer the data in a buffer while the application processor of the first UE is in the lower power state; and
transfer buffered data from the buffer to the application processor after the application processor exits the lower power state and enters an active state.
